(19) United States
(12) Patent Application Publication
(10) Pub. No.: US 2016/0032225 A1
(43) Pub. Date: Feb. 4, 2016

(54) SINGLE PHASE AUTOMATIC DISHWASHING DETERGENT COMPOSITION

(71) Applicant: CHURCH & DWIGHT CO., INC., Princeton, NJ (US)

(72) Inventors: Kevin KAVCHOK, New Egypt, NJ (US); Lisa MUENTENER, Stewartsville, NJ (US); Bruce CONLEY, Hamilton, NJ (US)

(21) Appl. No.: 14/446,681

(22) Filed: Jul. 30, 2014

(51) Int. Cl. C11D 3/39; C11D 3/08; C11D 1/72; C11D 3/10; C11D 1/74; C11D 3/386; C11D 3/20

(52) U.S. Cl. CPC C11D 3/3942; C11D 3/386; C11D 3/08; C11D 3/2086; C11D 3/10; C11D 1/74; C11D 1/72

(57) ABSTRACT

A single phase automatic dishwashing detergent composition includes, based on the total weight of the composition, a peroxide bleaching agent present in an amount of at least 30.0% by weight, a mixture of detergent builders having a) a silicate present in an amount of at least 15.0% by weight, b) a citrate present in an amount of at least 5.0% by weight, and c) a carbonate present in an amount of at least 5.0% by weight, a surfactant present in an amount of at least 0.1% by weight, a detergent polymer present in an amount of at least 2.0% by weight, and an enzyme present in an amount of at least 1.0% by weight, wherein the composition is essentially free of phosphate compounds.

### FIELD OF THE INVENTION

The present invention relates to detergent compositions, and more particularly to a single phase automatic dishwashing detergent composition exhibiting enhanced stability and cleaning efficacy over a range of different stains and soils.

### BACKGROUND OF THE INVENTION

Automatic dishwashing machines are designed to clean dishware and eating utensils with minimal user intervention. Typically, the automatic dishwashing machine is programmed to clean dishware using two or more cycles which includes at least one wash cycle followed by a rinse cycle. The dishwashing machines may allow the user to further select soaking, pre-washing, drying and/or additional washing and rinsing cycles. Automatic dishwashing detergent compositions formulated for use with dishwashing machines generally contain alkaline salts, bleaches, bleach activators, anti-corrosion agents, builders, enzymes, surfactants and the like. During washing, the detergent composition is dissolved to produce a wash solution prior to its application on the soiled dishware or utensils. Once washing is complete, the wash solution containing stain and soil materials is drained.

Legislative bans on the use of phosphates in automatic dishwashing detergent compositions have necessitated the replacement of phosphate-based automatic dishwashing detergent compositions with those that are phosphate-free. Because phosphates are excellent for removing food deposits and residues, the elimination of phosphates has significantly reduced cleaning efficacy as compared to phosphate-based automatic dishwashing detergent compositions. Single phase phosphate-free automatic dishwashing detergent compositions have been found by most consumers to be less than satisfactory because they do not perform well in single phase systems or are too expensive because they require multiple phase delivery systems.

Newer formulations containing multiple phases must be processed and packaged separately to avoid stability issues, thus significantly increasing manufacturing costs. These multiple phase automatic dishwashing detergent compositions have also been offered in unit dose forms for added convenience. The unit dose forms of the multiple phase automatic dishwashing detergent compositions have been found to be popular among consumers for their cleaning efficacy and convenience. However, they are quite expensive for the average consumer due to manufacturing costs associated with packaging multiple phase components into unit dose products.

Accordingly, there is a need for a single phase automatic dishwashing composition that is phosphate-free, has excellent stain and soil removal performance, is simple and economical to make and use, and maintains excellent product stability. There is a further need for a single phase automatic dishwashing composition that is more economical than multiple phase unit dose detergent products, while providing cleaning performance and efficacy and product stability that is at least comparable to or better than such products. There is a need for a single phase automatic dishwashing composition that provides greater cleaning power at lower dosage requirements for each wash, thereby realizing enhanced environmental benefits through lower transportation and storage costs.

### SUMMARY OF THE INVENTION

The present invention relates to a single phase automatic dishwashing detergent composition possessing excellent cleaning performance and efficacy in removing stains and soils from dishware and exhibiting excellent product stability. The single phase automatic dishwashing detergent composition of the present invention is especially formulated for cleaning stained and/or soiled substrates, such as, for example, dishware, cookware, bakeware, and eating utensils. The present automatic dishwashing detergent composition is prepared as a single phase formulation with cleaning efficacy, convenience and product stability at least comparable to or better than multiple phase automatic dishwashing detergent compositions and, in particular, the unit dose forms thereof. The present automatic dishwashing detergent composition is specifically formulated as a stable, single phase product, thereby avoiding the processing expenses typically associated with multiple phase compositions having visually separated components and, particularly, unit dose forms thereof. The single phase automatic dishwashing detergent composition of the present invention provides the consumer with a higher performing product at a much lower manufacturing cost.

In one aspect of the present invention there is provided a single phase automatic dishwashing detergent composition in which there is a select group of ingredients combined in selected amounts which enable the product to generate high cleaning efficiency, excellent peroxide stability, and potent peroxide delivery without the need for multiple phases such as encapsulating visually separate groups of ingredients and/or providing the product in unit dose delivery system.

In another aspect of the present invention, there is provided a single phase automatic dishwashing detergent composition comprising, based on the total weight of the composition:

a peroxide bleaching agent present in an amount of at least 30.0% by weight;

a mixture of detergent builders comprising:
a) a silicate present in an amount of at least 15.0% by weight;
b) a citrate present in an amount of at least 5.0% by weight; and
c) a carbonate present in an amount of at least 5.0% by weight;

a surfactant present in an amount of at least 0.1% by weight;

a detergent polymer present in an amount of at least 2.0% by weight; and

an enzyme present in an amount of at least 1.0% by weight,

wherein the composition is essentially free of phosphate compounds.

### BRIEF DESCRIPTION OF THE DRAWINGS

The following drawing is illustrative of preferred embodiments of the present invention, and is not intended to limit the invention as encompassed by the claims forming part of the application:

FIG. 1 is a graph showing mean scores comparing cleaning performance of commercial automatic dishwashing detergent compositions and those of the present invention on soiled dishware.

### DETAILED DESCRIPTION OF THE INVENTION

The present invention is directed to a single phase automatic dishwashing detergent composition possessing excellent cleaning performance and efficacy in removing stains and soils from dishware and exhibiting excellent product stability. The single phase automatic dishwashing detergent composition of the present invention is especially formulated for cleaning stained and/or soiled substrates, such as, for example, dishware, cookware, bakeware, and eating utensils. The present automatic dishwashing detergent composition is prepared as a single phase formulation with cleaning efficacy, convenience and product stability at least comparable to or better than multiple phase automatic dishwashing detergent compositions and, in particular, the unit dose forms thereof. The present automatic dishwashing detergent composition are specifically formulated as a stable, single phase product, thereby avoiding the processing expenses typically associated with multiple phase compositions and, particularly, unit dose forms thereof. The single phase automatic dishwashing detergent composition of the present invention provides the consumer with a higher performing product at a much lower manufacturing cost.

The present single phase automatic dishwashing detergent composition performs well and more consistently over a broader range of stain and soil conditions than the costlier multiple phase detergent compositions. The present single phase automatic dishwashing detergent composition offers a potent combination of relatively high levels of peroxide and silicate, and other ingredients that can be processed and packaged together (single phase) for improved cost effectiveness without compromising cleaning efficacy or product stability. The single phase automatic dishwashing detergent composition further includes surfactants, detergent polymers and enzymes suitable for breaking down protein- and starch-based food residues and deposits.

The term “dishware” as used herein refers to any substrate including, but not limited to, glassware, cookware, bakeware, bowls, dishes, dinner plates, drinking cups, containers, pots and pans, cooking and eating utensils, and any food/drink handling articles that typically requires treatment in an automatic dishwashing machine to remove any food residues deposited thereon.

The term “single phase” as used herein refers to an automatic dishwashing detergent composition in which all of the ingredients are combined without visual separation or segregation of two or more ingredients from the others. The single phase composition appears substantially visually homogenous.

The term “automatic dishwashing machine” as used herein refers to any apparatus or device configured for removing stains and soils from dishware in a manner which results in cleaning, washing, sanitizing, and rinsing of the dishware. Such automatic dishwashing machines typically operate in three or more cycles: a pre-wash cycle, a main wash cycle and one or more rinse cycles.

In one typical example, the pre-wash cycle is typically a cycle lasting from about 5 to 10 minutes. In the main wash cycle, the water is heated to a temperature of from about 50° C. to 65° C. Ranges in water temperature are influenced by many factors including differences between machine manufacturers, dishwasher wash options such as “added heat” or “hot wash”, consumer water heater temperature settings, distance between the consumer's dishwasher and hot water heater, dishwasher load size, etc. The main wash cycle typically lasts for about 30 minutes. Rinsing usually comprises one or more separate cycles following the main wash cycle lasting from about 5 to 20 minutes. The wash solution in many automatic dishwashing machines is constantly recirculated through a filter to trap food particles therefore reducing food soil redeposition. The filter is then flushed during the drain cycle. It is noted that automatic dishwashing machines are typically hot water feeds. However, the temperature is reduced when the water comes in contact with the cooler surfaces of the dishes and interior of the washer. Many automatic dishwashing machines turn the heating element on during the wash and rinse cycles to heat the wash and/or rinse solutions to the desired wash temperatures.

The present automatic dishwashing detergent composition is specifically formulated for removing stains and soils from dishware during a main wash cycle in automatic dishwashing machines. The components or ingredients of the present automatic dishwashing detergent composition are formulated essentially as a single phase composition to work more efficiently during the main wash cycle, due to the temperature and duration of the main wash cycle. Thus, the present automatic dishwashing composition is preferably used for the main wash cycle. The present automatic dishwashing detergent composition is placed into the main wash dispenser that automatically opens at the start of the main wash cycle. Some dispensers include apertures which allow water ingress prior to releasing the automatic dishwashing detergent composition during the main wash cycle.

In one embodiment of the present invention, there is provided a single phase automatic dishwashing detergent composition including, based on the total weight of the composition, a peroxide bleaching agent present in an amount of at least 30.0% by weight, a mixture of detergent builders having a) a silicate present in an amount of at least 15.0% by weight, b) a citrate present in an amount of at least 5.0% by weight, and c) a carbonate present in an amount of at least 5.0% by weight, a surfactant present in an amount of at least 0.1% by weight, a detergent polymer present in an amount of at least 2.0% by weight, and an enzyme present in an amount of at least 1.0% by weight, wherein the composition is essentially free of phosphate compounds.

In a particular embodiment of the present invention, the automatic dishwashing detergent composition includes a peroxide bleaching agent selected from oxygen bleaching compounds that contains and/or liberates the peroxide ion. Preferably, the peroxide bleaching agent is coated or encapsulated. Suitable peroxide bleaching agents may be selected, for example, from sodium perborate, sodium percarbonate, polyvinylpyrrolidone peroxide, benzoyl peroxide, sodium peroxide, and combinations thereof.

A preferred peroxide bleaching agent is sodium percarbonate, and more preferably sodium percarbonate coated with a layer of sodium sulfate for improved stability. The sodium sulfate coating creates a barrier between sodium percarbonate and the components in the formulation of the present invention resulting in an improved stability profile. The peroxide bleaching agent is present in the automatic dishwashing detergent composition of the present invention in elevated amounts of at least 30.0% by weight based on the total weight of composition, more preferably from about 30.0% to 60.0% by weight, and most preferably about 36.0% by weight. A suitable coated sodium percarbonate product is PROVOX® C (CAS No. 15630-89-4) available commercially from OCI Chemical Corporation of Atlanta, Ga.

In a further embodiment of the present invention, the automatic dishwashing detergent composition includes a) a silicate present in an elevated amount of at least 15.0% by weight, b) a citrate present in an amount of at least 5.0% by weight, and c) a carbonate present in an amount of at least 5.0% by weight, each based on the total weight of the composition.

In a preferred embodiment of the present invention, the silicate is present in an amount of from about 15.0% to 30.0% by weight, and more preferably about 22.0% by weight. The silicate may be selected from alkali metal silicates such as, for example, sodium silicate. A suitable sodium silicate product is BRITESIL® H20 hydrous sodium silicate (CAS No. 1344-09-8) available commercially from PQ Corporation of Valley Forge, Pa.

In a preferred embodiment of the present invention, the citrate is present in an amount of from about 5.0% to 20.0% by weight, and more preferably about 16.0% by weight. The citrate may be selected from alkali metal citrates such as, for example, sodium citrate.

In a preferred embodiment of the present invention, the carbonate is present in an amount of from about 5.0% to 20.0% by weight, and more preferably about 14.7% by weight. The carbonate may be selected from alkali metal carbonates such as, for example, sodium carbonate.

In a further embodiment of the present invention, the automatic dishwashing detergent composition includes a surfactant in an amount sufficient to enable detersive action against stain and/or soil deposited on the dishware. The surfactants may be, for example, selected from suitable surface active compounds which are commercially available and described in the literature, e.g., in “Surface Active Agents and Detergents,” Volumes 1 and 2 by Schwartz, Perry and Berch.

Preferably, the surfactant of the present invention may be selected from a nonionic surfactant. The nonionic surfactant may include mixtures of two or more nonionic surfactants formulated into the automatic dishwashing detergent composition of the present invention.

In a preferred embodiment of the present invention, the surfactant is present in an amount of at least 0.1% by weight based on the total weight of the automatic dishwashing detergent composition, more preferably from about 0.1% to 10% by weight, and most preferably about 5.0% by weight.

Suitable nonionic surfactants may be selected, for example, from fatty alcohol ethyoxylates, fatty alcohol polyglycol ethers, and combinations thereof.

Preferred fatty alcohol ethoxylates may be selected from C12-C18 fatty alcohol ethoxylates, and combinations thereof. A suitable C12-C18 fatty alcohol ethoxylate product is ETHOX® SLF-18 available commercially from Ethox Chemicals, LLC of Greenville, S.C.

Preferred fatty alcohol polyglycol ethers may be selected from alkylpolyethylene glycol ethers made from a linear, saturated C16-C18 fatty alcohol; polyoxyethylene-8 tridecyl ether; and combinations thereof. Suitable fatty alcohol polyglycol ether products may include DEHYPON® GRA, LUTENSOL® A8, and LUTENSOL® AT11, each available commercially from BASF of Florham Park, N.J.

In a preferred embodiment of the present invention, the surfactant comprises a mixture of two or more nonionic surfactants. Preferably, the nonionic surfactant mixture comprises a combination of a fatty alcohol ethoxylate and a fatty alcohol polyglycol ether. Such mixtures provide a broad range cloud point that allows the product to perform well under varying water temperature ranges. The addition of C12-C18 fatty alcohol ethoxylate facilitates fragrance and particle distribution in the present formulation. The addition of fatty alcohol polyglycol ether in the present formulation promotes rinse aid benefits including reduced spotting.

The fatty alcohol ethoxylate is present in an amount of at least 2.0% by weight based on the total weight of the automatic dishwashing detergent composition, more preferably from about 2.0% to 4.5% by weight, and most preferably about 3.5% by weight. The fatty alcohol polyglycol ether is present in an amount of at least 0.5% by weight based on the total weight of the automatic dishwashing detergent composition, more preferably from about 0.5% to 2.0% by weight, and most preferably about 0.9% by weight.

In a further embodiment of the present invention, the automatic dishwashing detergent composition includes one or more enzymes selected for promoting enzymatic removal of stains and/or soils from dishware. Suitable enzymes include those selected from proteases, lipases, cutinases, amylases, pullulanases, xylanases, hemicellulases, cellulases, peroxidases, oxidases, mannanases, and combinations thereof. More preferred enzymes are selected from amylase, protease, and combinations thereof.

In a preferred embodiment of the present invention, the enzyme is present in an amount of at least 1.0% by weight based on the total weight of the automatic dishwashing detergent composition, preferably from about 1.0% to 5% by weight, more preferably about 1.6% by weight. A suitable enzyme product is TWIN POWER™ enzymes available commercially from Novozymes A/S of Bagsvaerd, Denmark.

In a further embodiment of the present invention, the automatic dishwashing detergent composition includes a detergent polymer selected for dispersing of stains and/or soils from dishware and preventing their redeposition on the surfaces of the dishware. The detergent polymer may be selected from organic polymers such as, for example, acrylic acid containing polymers (e.g., polycarboxylates, and salts thereof).

The detergent polymer is present in an amount of at least 2.0% by weight based on the total weight of the automatic dishwashing detergent composition, preferably from about 2.0% to 5.0% by weight, and more preferably about 4.0% by weight. A suitable detergent polymer product is ACUSOL® 445ND manufactured by Rohm & Haas Company of Philadelphia, Pa.

The automatic dishwashing detergent composition of the present invention may include various other components such as, for example, fragrance, coloring agents, flow control agents, stabilizers, and other functional ingredients at suitable functionally desirable levels.

All the percentages disclosed herein are by weight of the composition, unless stated otherwise.

### EXAMPLES

### Example 1

An automatic dishwashing detergent composition of the present invention was prepared in the form of a powder, and formulated with the following ingredients listed in Table 1 below.

TABLE 1

| | Amount (% by |
|---|---|
| Ingredient | weight) |
| Sodium Percarbonate, Coated | 36.0 |
| Sodium Silicate | 22.0 |
| Sodium Citrate | 16.0 |
| Sodium Carbonate | 14.7 |
| C12-C18 Alcohol Ethoxylate | 3.5 |
| Fatty Alcohol Polyglycol Ether | 0.9 |
| Polycarboxylate, Sodium Salt | 4.0 |
| Amylase and Protease Blend | 1.6 |
| Sodium Aluminosilicate | 0.8 |
| Spectra-Flecks FD&C Blue #1 | 0.3 |
| Fragrance | 0.2 |
| Total | 100.0 |

### Example 2

### Evaluation of Automatic Dishwashing Detergent Compositions for Stain/Soil Removal

Various automatic dishwashing detergent compositions were evaluated using 4″×4″ melamine resin-based test tiles coated with corresponding stains or soils. The test tiles prepared by Center for Testmaterials BV of Vlaardingen, the Netherlands, were obtained from Test Fabrics Inc. of West Pittston, Pa. The test tiles are used as a standard in the fabric and hard surface cleaners industry for monitoring and testing cleaning efficacy of detergent compositions. For the present evaluations, the stains and soils tested are listed in Table 2 below.

TABLE 2

| Tile Coating | CFT Code |
|---|---|
| Stain: | |
| Tea | DM-11 |
| Coffee | DM-81 |
| Red Wine | DM-51 |
| Soil: | |
| Egg with Milk | DM-31 |
| Oatmeal/Chocolate | DM-54 |
| Double Soiled Minced Meat | DM-92 |
| Triple Soiled Mixed Starch, Colored | DM-377 |

### Parameters:

The test tiles were washed in AMANA® Model No. ADB1400YBO dishwashers under normal wash cycle with hot option (off) and heated dry (off) with water temperature input set at 120° F. and water hardness at about 300 ppm. The test was conducted using hard water to challenge the automatic dishwashing detergent compositions and to provide better differentiation between them. In addition to using hard water, 40 grams of powdered milk and 20 grams of margarine were added to the dishwashers prior to testing.

### Automatic Dishwashing Detergent Compositions Evaluated:

The automatic dishwashing detergent compositions selected for evaluation are listed as follows:

1) CASCADE® with DAWN® Action Packs;

2) CASCADE COMPLETE® Action Packs;

3) CASCADE® PLATINUM;

4) FINISH® POWERBALL®;

5) FINISH® QUANTUM® POWERBALL®; and

6) Automatic Dishwashing Detergent Composition of the Present Invention.

### Evaluation Method:

For stained test tiles, the performance of the automatic dishwashing detergent was evaluated by measuring percent stain removal through the use of a calorimeter. Readings were collected before and after wash. The readings were taken on 3 different areas of each test tile and averaged.

For soiled test tiles, the performance of the automatic dishwashing detergent was evaluated by measuring percent soil removal through visual inspection, since the test tiles are typically blotchy and not uniform upon washing.

### Results:

The results of the stain removal evaluation for each of the automatic dishwashing detergent compositions tested are provided in Table 3 below.

TABLE 3
Stained Test Tiles.

| | | | | | | Automatic |
|---|---|---|---|---|---|---|
| | CASCADE ® | | | | | Dishwashing |
| | with | | | | | Detergent |
| | DAWN ® | CASCADE | | | FINISH ® | Composition of |
| | Action | COMPLETE ® | CASCADE ® | FINISH ® | QUANTUM ® | the Present |
| | Packs | Action Packs | PLATINUM ® | POWERBALL ® | POWERBALL ® | Invention |
| Coffee | 54 | 39 | 61 | 61 | 61 | 61 |
| Tea | 71 | 37 | 40 | 69 | 69 | 78 |
| Red Wine | 30 | 46 | 35 | 74 | 74 | 78 |
| Total | 155 | 122 | 114 | 204 | 204 | 217 |
| Stain | | | | | | |

The results of Table 3 were obtained by measuring percentage of stain removal (%SR) using a colorimeter. Readings were collected before and after each wash on three different areas of each tile and then averaged using the following equation:

$$\% SR = \frac{( ( \begin{matrix}unsoiled tile reading \text{-} \\ average “ before ” reading\end{matrix} ) - ( \begin{matrix}unsoiled tile reading \text{-} \\ averaged “ after ” reading\end{matrix} )}{( unsoiled tile reading \text{-} average “ before ” reading ) ) \times 100} \times 100$$

The values obtained represent percentage of soil removed. Values were added to obtain a total cleaning score.

The results of the soil removal evaluation for each of the automatic dishwashing detergent compositions tested are provided in Table 4 below.

TABLE 4
Soiled Test Tiles.

| | | | | | | Automatic |
|---|---|---|---|---|---|---|
| | | | | | | Dishwashing |
| | CASCADE ® | | | | | Detergent |
| | with | | | | | Composition |
| | DAWN ® | CASCADE | | | FINISH ® | of the |
| | Action | COMPLETE ® | CASCADE ® | FINISH ® | QUANTUM ® | Present |
| | Packs | Action Packs | PLATINUM ® | POWERBALL ® | POWERBALL ® | Invention |
| Starch | 0 | 74 | 76 | 54 | 68 | 78 |
| Meat | 15 | 100 | 99 | 99 | 99 | 99 |
| Oatmeal/ | 25 | 100 | 99 | 98 | 98 | 99 |
| Chocolate | | | | | | |
| Egg with Milk | 10 | 95 | 98 | 85 | 85 | 90 |
| Total Soil | 50 | 369 | 372 | 336 | 350 | 366 |

The results of Table 4 were obtained through visual measurements due to the blotchy and non-uniform appearance of the soiled tiles. The values represent percentage of soil removal, and were added to obtain a total cleaning score.

The results from the stain and soil removal evaluations were added together for each of the automatic dishwashing detergent compositions to compare overall performance as indicated in Table 5 below.

TABLE 5

| Automatic Dishwashing Detergent Composition | Total Stain + Soil |
|---|---|
| CASCADE ® with DAWN ® Action Packs | 205 |
| CASCADE COMPLETE ® Action Packs | 491 |
| CASCADE ® PLATINUM ® | 486 |
| FINISH ® POWERBALL ® | 540 |
| FINISH ® QUANTUM ® POWERBALL ® | 554 |
| Automatic Dishwashing Detergent Composition of the | 583 |
| Present Invention | |

### Conclusion:

When compared to the leading automatic dishwashing detergent products, the automatic dishwashing detergent composition of the present invention exhibited superior performance in nearly all stains and soils tested.

### Example 3

### Evaluation of Automatic Dishwashing Detergent Compositions for Stain/Soil Removal

The present evaluation was implemented to measure performance of various automatic dishwashing detergent compositions on several consumer relevant soil/dishware combinations utilizing internal sensory panelists. Five replicates were conducted and paneled by 55 respondents for a total of 275 data points.

Test parameters:

The soiled cutlery and dinnerware were washed in GE® Model No. GDWF100VBB dishwashers under normal wash cycle with hot option (off) and heated dry (on) with water temperature input set at 120° F. and water hardness at about 150 ppm.

### Products and Dosage:

The automatic dishwashing detergent compositions and corresponding dosages used for the evaluation are listed in Table 6 below.

TABLE 6

| Automatic Dishwashing Detergent | |
|---|---|
| Composition | Dosage |
| 1. Automatic Dishwashing | 18 grams added to main wash |
| Detergent Composition of the | dispenser |
| Present Invention | |
| 2. CASCADE ® Base Powder | 25 grams added to pre-wash; 50 |
| with DAWN ® Grease Fighting | grams added to main wash |
| Power, Lemon Scent | dispenser |
| 3. CASCADE ® Base Gel | 25 grams added to pre-wash; 50 |
| with DAWN ® Grease Fighting | grams added to main wash |
| Power, Lemon Scent | dispenser |
| 4. OXICLEAN ® Unit Dose, | 1 pod (18 grams) added to main |
| Lemon Scent | wash dispenser |
| 5. CASCADE ® Base Unit Dose | 1 pod added to main wash dispenser |
| with DAWN ® Grease Fighting | |
| Power, Fresh Scent | |
| 6. FINISH ® POWERBALL ® | 1 tab added to the main wash |
| | dispenser |

### Soils/Dishware:

A number of soils were selected for use in the present evaluation. The soils include oil and greasy food (ground beef), coffee, cheese-containing food (au gratin potatoes, lasagna), farina/hot cereal (oatmeal) and eggs. The soils were prepared using foods purchased from a local supermarket and applied to eatery utensils and dinnerware that would be typically found in a consumer's home to yield soiled dishware. The resulting soiled dishware were air dried overnight. Soiled dinner plates and silverware were also used along with the soiled dishware in simulating a normal load. The soiled dinner plates and silverware were excluded from the evaluation process after the wash.

The soiled dishware used in the evaluation are listed as follows:

1. Tomato sauce on plastic storage container;

2. Ground beef on stainless frying pan;

3. Eggs on spatula;

4. Coffee on coffee mug;

5. Au gratin Potatoes on casserole dish;

6. Lasagna on glass dish;

7. Oatmeal in ceramic bowl; and

8. Milk in glass.

### Sensory Evaluation Methodology:

The present evaluation utilized sequential monadic testing with randomized complete block design, whereby panelists were asked to rate the cleaning performance of each automatic dishwashing detergent composition on the soiled dishware. Five washload replications were implemented for each automatic dishwashing detergent composition. Each panelist completed each replication in 2 visits, as the panelists evaluated 3 sets of dishware in one visit. The test was repeated 4 more times with the same panelists returning to evaluate the replication. Each dishware was rated using a 0-100 points line scale (Clean—Dirty) below:

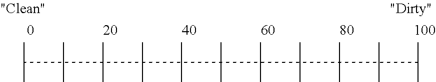

According to the points line scale shown above, references for “Clean” (no stain/soil or any other residues)=0 and “Dirty” (a lot of stain/soil and other residues)=100 for each dishware were provided. The evaluation was conducted in the Sensory Lab utilizing the sensory booths. Each booth was designated for one product. The “dirty”=100 references were placed in each booth for the panelists to compare each dishware to, while the “clean”=0 was available in the Sensory Lab hallway for them to use if needed to assist with their evaluation.

### Results:

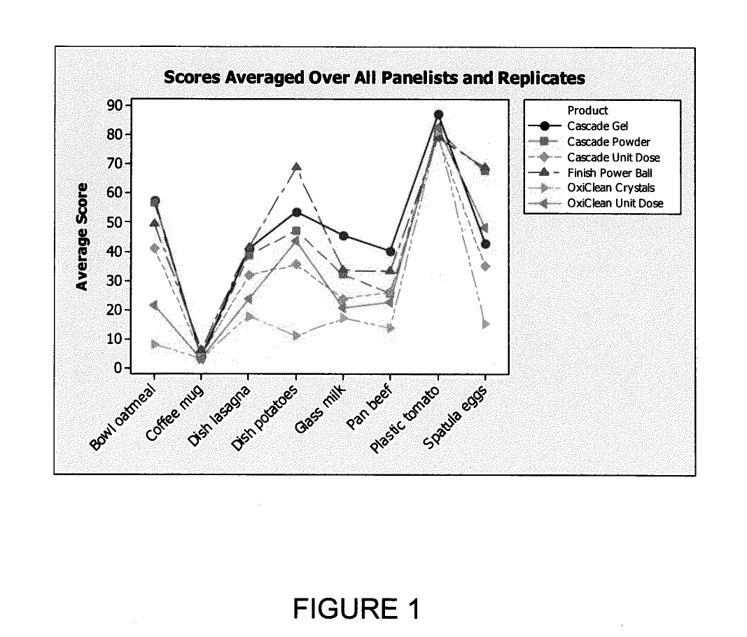

Referring to FIG. 1, a graph is shown plotting evaluation scores averaged over all the panelists for each of the automatic dishwashing detergent compositions and the corresponding soiled dishware. The results of the testing indicate that automatic dishwashing detergent composition of the present invention scored higher than the commercial automatic dishwashing detergent compositions in terms of cleaning performance for nearly all the soiled dishware evaluated, specifically, bowl oatmeal, dish lasagna, dish potatoes, glass milk, pan beef, and spatula eggs. For coffee mug and plastic tomato, the automatic dishwashing detergent composition of the present invention scored slightly better than or comparable to the commercial automatic dishwashing detergent compositions.

A summary of the mean scores for each automatic dishwashing detergent composition as evaluated by the panelists is provided in Table 7 below.

TABLE 7
Summary of Mean Score for each product

| Automatic Dishwashing Detergent | | | | |
|---|---|---|---|---|
| Composition | Mean | Grouping* | | |
| Automatic Dishwashing Detergent Composition | 20 | A | | |
| of the Present Invention | | | | |
| OXICLEAN ® Unit Dose, Lemon Scent | 33 | | B | |
| CASCADE ® Base Unit Dose with DAWN ® | 35 | | B | |
| Grease Fighting Power, Fresh Scent | | | | |
| CASCADE ® Base Powder with DAWN ® | 45 | | | C |
| Grease Fighting Power, Lemon Scent | | | | |
| FINISH ® POWERBALL ® | 46 | | | C |
| CASCADE ® Base Gel with DAWN ® Grease | 47 | | | C |
| Fighting Power, Lemon Scent | | | | |

*Means that do not share a letter are significantly different.

Each of the automatic dishwashing detergent compositions were placed into groupings represented by letters A, B and C, respectively, using Tukey's range test at 95% CL. Members within same group are considered substantially the same in terms of cleaning performance, while those of different groups are significantly different. Thus, both OXICLEAN® Unit Dose, Lemon Scent, and CASCADE® Base Unit Dose with DAWN® Grease Fighting Power, Fresh Scent, are members of grouping “B” and thus were not considered significantly different from each other in terms of cleaning performance. The members of grouping “B” were found to be significantly better than the members of grouping “C” (i.e., CASCADE® Base Powder with DAWN® Grease Fighting Power, Lemon Scent, FINISH® POWERBALL®, and CASCADE® Base Gel with DAWN® Grease Fighting Power, Lemon Scent). The automatic dishwashing detergent composition of the present invention as the sole member of grouping “A” was considered significantly better than the other five commercial automatic dishwashing detergent compositions tested at 95%CL.

Summaries of the mean scores for each automatic dishwashing detergent composition and their corresponding groupings on the basis of soiled dishware type are provided in Tables 8 through 15, respectively, below.

TABLE 8
Summary of Mean Score for Bowl of Oatmeal

| Automatic Dishwashing | | | | | | |
|---|---|---|---|---|---|---|
| Detergent Composition | Mean | Grouping* | | | | |
| Automatic Dishwashing Detergent | 8 | A | | | | |
| Composition of the Present Invention | | | | | | |
| OXICLEAN ® Unit Dose, Lemon Scent | 21 | | B | | | |
| CASCADE ® Base Unit Dose with | 40 | | | C | | |
| DAWN ® Grease Fighting Power, | | | | | | |
| Fresh Scent | | | | | | |
| FINISH ® POWERBALL ® | 49 | | | | D | |
| CASCADE ® Base Powder with | 57 | | | | | E |
| DAWN ® Grease Fighting Power, | | | | | | |
| Lemon Scent | | | | | | |
| CASCADE ® Base Gel with DAWN ® | 61 | | | | | E |
| Grease Fighting Power, Lemon Scent | | | | | | |

*Means that do not share a letter are significantly different.

TABLE 9
Summary of Mean Score for Coffee Mug

| Automatic Dishwashing Detergent | | |
|---|---|---|
| Composition | Mean | Grouping* |
| Automatic Dishwashing Detergent Composition | 3 | A |
| of the Present Invention | | |
| OXICLEAN ® Unit Dose, Lemon Scent | 3 | A |
| CASCADE ® Base Gel with DAWN ® Grease | 4 | A |
| Fighting Power, Lemon Scent | | |
| CASCADE ® Base Powder with DAWN ® Grease | 4 | A |
| Fighting Power, Lemon Scent | | |
| CASCADE ® Base Unit Dose with DAWN ® | 5 | A |
| Grease Fighting Power, Fresh Scent | | |
| FINISH ® POWERBALL ® | 5 | A |

*Means that do not share a letter are significantly different.

TABLE 10
Summary of Mean Score for Lasagna in PYREX ® Dish

| Automatic Dishwashing Detergent | | | | | |
|---|---|---|---|---|---|
| Composition | Mean | Grouping* | | | |
| Automatic Dishwashing Detergent | 19 | A | | | |
| Composition of the Present Invention | | | | | |
| OXICLEAN ® Unit Dose, Lemon Scent | 28 | | B | | |
| CASCADE ® Base Unit Dose with | 35 | | B | C | |
| DAWN ® Grease Fighting Power, Fresh | | | | | |
| Scent | | | | | |
| CASCADE ® Base Powder with DAWN ® | 42 | | | C | D |
| Grease Fighting Power, Lemon Scent | | | | | |
| FINISH ® POWERBALL ® | 43 | | | | D |
| CASCADE ® Base Gel with DAWN ® | 43 | | | | D |
| Grease Fighting Power, Lemon Scent | | | | | |

*Means that do not share a letter are significantly different.

TABLE 11
Summary of Mean Score for Au Gratin Potatoes in Casserole Dish

| Automatic Dishwashing Detergent | | | | | |
|---|---|---|---|---|---|
| Composition | Mean | Grouping* | | | |
| Automatic Dishwashing Detergent | 12 | A | | | |
| Composition of the Present Invention | | | | | |
| CASCADE ® Base Unit Dose with | 38 | | B | | |
| DAWN ® Grease Fighting Power, Fresh | | | | | |
| Scent | | | | | |
| OXICLEAN ® Unit Dose, Lemon Scent | 42 | | B | | |
| CASCADE ® Base Powder with DAWN ® | 51 | | | C | |
| Grease Fighting Power, Lemon Scent | | | | | |
| CASCADE ® Base Gel with DAWN ® | 54 | | | C | |
| Grease Fighting Power, Lemon Scent | | | | | |
| FINISH ® POWERBALL ® | 66 | | | | D |

*Means that do not share a letter are significantly different.

TABLE 12
Summary of Mean Score for Milk in Glass

| Automatic Dishwashing Detergent | | | | | |
|---|---|---|---|---|---|
| Composition | Mean | Grouping* | | | |
| Automatic Dishwashing Detergent | 15 | A | | | |
| Composition of the Present Invention | | | | | |
| OXICLEAN ® Unit Dose, Lemon Scent | 19 | A | B | | |
| CASCADE ® Base Unit Dose with | 24 | | B | | |
| DAWN ® Grease Fighting Power, Fresh | | | | | |
| Scent | | | | | |
| CASCADE ® Base Powder with | 33 | | | C | |
| DAWN ® Grease Fighting Power, | | | | | |
| Lemon Scent | | | | | |
| FINISH ® POWERBALL ® | 34 | | | C | |
| CASCADE ® Base Gel with DAWN ® | 44 | | | | D |
| Grease Fighting Power, Lemon Scent | | | | | |

*Means that do not share a letter are significantly different.

TABLE 13
Summary of Mean Score for Ground Beef in Frying Pan

| Automatic Dishwashing Detergent | | | | | |
|---|---|---|---|---|---|
| Composition | Mean | Grouping* | | | |
| Automatic Dishwashing Detergent | 13 | A | | | |
| Composition of the Present Invention | | | | | |
| OXICLEAN ® Unit Dose, Lemon Scent | 21 | | B | | |
| CASCADE ® Base Unit Dose with | 26 | | B | | |
| DAWN ® Grease Fighting Power, Fresh | | | | | |
| Scent | | | | | |
| CASCADE ® Base Powder with DAWN ® | 27 | | B | C | |
| Grease Fighting Power, Lemon Scent | | | | | |
| FINISH ® POWERBALL ® | 31 | | | C | |
| CASCADE ® Base Gel with DAWN ® | 41 | | | | D |
| Grease Fighting Power, Lemon Scent | | | | | |

*Means that do not share a letter are significantly different.

TABLE 14
Summary of Mean Score for Tomato Sauce on Plastic Container

| | | |
|---|---|---|
| Automatic Dishwashing Detergent | | |
| Composition | Mean | Grouping* |

| | | | |
|---|---|---|---|
| FINISH ® POWERBALL ® | 75 | A | |
| CASCADE ® Base Unit Dose with | 76 | A | |
| DAWN ® Grease Fighting Power, | | | |
| Fresh Scent | | | |
| Automatic Dishwashing Detergent | 77 | A | |
| Composition of the Present Invention | | | |
| CASCADE ® Base Powder with | 78 | A | B |
| DAWN ®Grease Fighting Power, | | | |
| Lemon Scent | | | |
| OXICLEAN ® Unit Dose, | 79 | A | B |
| Lemon Scent | | | |
| CASCADE ® Base Gel with | 85 | | B |
| DAWN ®Grease Fighting Power, | | | |
| Lemon Scent | | | |

*Means that do not share a letter are significantly different.

TABLE 15
Summary of Mean Score for Eggs on Plastic Spatula

| Automatic Dishwashing Detergent | | | | | |
|---|---|---|---|---|---|
| Composition | Mean | Grouping* | | | |
| Automatic Dishwashing Detergent | 15 | A | | | |
| Composition of the Present Invention | | | | | |
| CASCADE ® Base Unit Dose with | 37 | | B | | |
| DAWN ® Grease Fighting Power, Fresh | | | | | |
| Scent | | | | | |
| CASCADE ® Base Gel with DAWN ® | 45 | | | C | |
| Grease Fighting Power, Lemon Scent | | | | | |
| OXICLEAN ® Unit Dose, Lemon Scent | 48 | | | C | |
| FINISH ® POWERBALL ® | 68 | | | | D |
| CASCADE ® Base Powder with DAWN ® | 70 | | | | D |
| Grease Fighting Power, Lemon Scent | | | | | |

*Means that do not share a letter are significantly different.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A single phase automatic dishwashing detergent composition comprising, based on the total weight of the composition:
a peroxide bleaching agent present in an amount of about 30% to about 60% by weight;
a mixture of detergent builders comprising:
a) a silicate present in an amount of about 15% to about 30% by weight;
b) a citrate present in an amount of about 5% to about 20% by weight; and
c) a carbonate present in an amount of about 5% to about 20% by weight;
a nonionic surfactant present in an amount of about 0.1% to about 10% by weight;
a detergent polymer present in an amount of at least about 2% to about 5% by weight; and
an enzyme present in an amount of about 1% to about 5% by weight,
wherein the composition is free of phosphate compounds.

2. The composition of claim 1 wherein the peroxide bleaching agent is an alkali metal percarbonate.

3. The composition of claim 1 wherein the peroxide bleaching agent is coated.

4. (canceled)

5. The composition of claim 1 wherein the silicate is an alkali metal silicate.

6. (canceled)

7. The composition of claim 1 wherein the citrate is an alkali metal citrate.

8. (canceled)

9. The composition of claim 1 wherein the carbonate is an alkali metal carbonate.

10-12. (canceled)

13. The composition of claim 1 wherein the nonionic surfactant comprises a combination of a fatty alcohol ethoxylate and a fatty alcohol polyglycol ether.

14. The composition of claim 13 wherein the fatty alcohol ethoxylate is present in an amount of at least 2.0% by weight based on the total weight of the composition.

15. The composition of claim 14 wherein the fatty alcohol ethoxylate is present in an amount of from about 2.0% to 4.5% by weight.

16. The composition of claim 13 wherein the fatty alcohol polyglycol ether is present in an amount of at least 0.5% by weight based on the total weight of the composition.

17. The composition of claim 16 wherein the fatty alcohol polyglycol ether is present in an amount of from about 0.5% to 2.0% by weight.

18. (canceled)

19. The composition of claim 1 wherein the detergent polymer is a polycarboxylate.

20. (canceled)

21. A single phase automatic dishwashing detergent composition comprising, based on the total weight of the composition:
an alkali metal percarbonate present in an amount of 30% to 60% by weight;
an alkali metal silicate;
an alkali metal citrate;
an alkali metal carbonate;
a fatty alcohol polyglycol ether;
a fatty alcohol ethoxylate;
a polycarboxylate; and
an enzyme;
wherein the composition is free of phosphate compounds.

22. The composition of claim 21, wherein:
the alkali metal silicate is present in an amount of 15% to 30% by weight;
the alkali metal citrate is present in an amount of 5% to 20% by weight;
the alkali metal carbonate is present in an amount of 5% to 20% by weight;
the fatty alcohol polyglycol ether is present in an amount of 0.5% to 2% by weight;
the fatty alcohol ethoxylate is present in an amount of 2% to 4.5% by weight;
the polycarboxylate is present in an amount of 2% to 5% by weight; and
the enzyme is present in an amount of 1% to 5% by weight.

23. The composition of claim 21, wherein the alkali metal percarbonate is in a coated or encapsulated form.

24. The composition of claim 23, wherein the alkali metal percarbonate is coated or encapsulated by an alkali metal sulfate.
